(19) United States
(12) Patent Application Publication
(10) Pub. No.: US 2022/0335946 A1
(43) Pub. Date: Oct. 20, 2022

(54) ELECTRONIC DEVICE AND METHOD FOR ANALYZING SPEECH RECOGNITION RESULTS

(71) Applicant: Samsung Electronics Co., Ltd., Suwon-si (KR)

(72) Inventor: Changyong JEON, Suwon-si (KR)

(21) Appl. No.: 17/745,328

(22) Filed: May 16, 2022

Related U.S. Application Data
(63) Continuation of application No. PCT/KR2022/000655, filed on Jan. 13, 2022.

(30) Foreign Application Priority Data
Feb. 19, 2021 (KR) 10-2021-0022572

(51) Int. Cl. G10L 15/26; G10L 25/27; G06F 40/279

(52) U.S. Cl. CPC G10L 15/26; G10L 25/27; G06F 40/279

(57) ABSTRACT

An electronic device and a method for analyzing a speech recognition result is provided. The electronic device includes a display module configured to provide information to an outside of the electronic device, a processor electrically connected to the display module, and a memory electrically connected to the processor. The processor is configured to generate feature information of a text corresponding to a user utterance based on the text, determine an output domain for processing the user utterance based on the feature information of the text, identify an expected domain predetermined by a user, extract, from the memory, feature information associated with the output domain and feature information associated with the expected domain, and display the feature information associated with the output domain and the feature information associated with the expected domain using the display module.

### CROSS-REFERENCE TO RELATED APPLICATION(S)

This application is a continuation application, claiming priority under § 365(c), of an International application No. PCT/KR2022/000655, filed on Jan. 13, 2022, which is based on and claims the benefit of a Korean patent application number 10-2021-0022572, filed on Feb. 19, 2021, in the Korean Intellectual Property Office, the disclosure of which is incorporated by reference herein in its entirety.

### BACKGROUND

### 1. Field

The disclosure relates to an electronic device and a method for analyzing speech recognition results. More particularly, the disclosure relates to an electronic device and a method that may verify pieces of feature information associated with a user utterance among pieces of feature information previously stored in a domain determined by a learning model for the user utterance and enable a developer to analyze a result of the learning model.

### 2. Description of Related Art

The development of speech recognition technology has increased the use of an artificial intelligence (AI)-based speech assistant in an electronic device, such as a smartphone. The speech assistant may recognize a user utterance and provide a service intended by a user.

To provide a service intended by a user, a domain for recognizing a user utterance and processing the service may need to be determined. For example, in response to a user's request to search for nearby restaurants, whether to provide a social app-based search result for nearby restaurants or a map app-based search result for nearby restaurants may need to be determined through a natural language processing process.

For the natural language processing process, machine learning-based learning models may be used. However, when a learning model fails to determine a domain for processing a user utterance, a computation process itself may not be readily analyzed, and a developer may not thus readily improve the performance of the learning model. Thus, there is a desire for a technology that enables a developer to verify pieces of data that affect a learning model in determining a domain for properly processing a user utterance.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method that verifies pieces of feature information associated with a user utterance among pieces of feature information previously stored in a domain determined by a learning model for the user utterance and enable a developer to analyze a result of the learning model.

Another aspect of the disclosure is to provide an electronic device and a method that displays, on a display module, pieces of feature information associated with a user utterance among pieces of feature information associated with a domain expected by a user and analyze a cause for the expected domain not being determined.

Additional aspects will be set forth in part in the description which follows and, in part, will be apparent from the description, or may be learned by practice of the presented embodiments.

In accordance with an aspect of the disclosure, an electronic device is provided. The electronic device includes a display module configured to provide information to an outside of the electronic device, a processor electrically connected to the display module, and a memory electrically connected to the processor. The processor generates feature information of a text corresponding to a user utterance based on the text, determine an output domain for processing the user utterance based on the feature information of the text, identify an expected domain that is predetermined by a user, extract, from the memory, feature information associated with the output domain and feature information associated with the expected domain, and display the feature information associated with the output domain and the feature information associated with the expected domain using the display module.

In accordance with another aspect of the disclosure, an electronic device is provided. The electronic device includes a display module configured to provide information to an outside of the electronic device, a processor electrically connected to the display module, and a memory electrically connected to the processor. The processor generates feature information of a text corresponding to a user utterance based on the text, determine an output domain for processing the user utterance based on the generated feature information of the text, extract, from the memory, feature information associated with the output domain, and display the feature information associated with the output domain using the display module.

In accordance with another aspect of the disclosure, a method of analyzing a speech recognition result is provided. The method includes generating feature information of a text corresponding to a user utterance based on the text, determining an output domain for processing the user utterance based on the feature information of the text, identifying an expected domain predetermined by a user, extracting feature information associated with the output domain and feature information associated with the expected domain, and displaying the feature information associated with the output domain and the feature information associated with the expected domain.

According to various embodiments described herein, pieces of feature information associated with a user utterance is verified from among pieces of feature information previously stored in a domain determined by a learning model for the user utterance, and thus a developer analyzes a result of the learning model.

According to various embodiments described herein, pieces of feature information associated with a user utterance among pieces of feature information associated with a domain expected by a user is displayed on a display module, and thus a cause for the expected domain not being determined is analyzed.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description, taken in conjunction with the accompanying drawings, in which:

FIG. 1 is a block diagram illustrating an electronic device in a network environment according to an embodiment of the disclosure;

FIG. 2 is a block diagram illustrating an of a speech recognition result analyzing module in an electronic device according to an embodiment of the disclosure;

FIGS. 3A and 3B are diagrams illustrating an of a text corresponding to a user utterance and classification information of the text according to various embodiments of the disclosure;

FIG. 4 is a diagram illustrating an of feature information of a text corresponding to a user utterance according to an embodiment of the disclosure;

FIG. 5 is a diagram illustrating an interface for inputting an expected domain according to an embodiment of the disclosure;

FIG. 6 is a diagram illustrating an interface for displaying feature information associated with an expected domain and an output domain according to an embodiment of the disclosure;

FIG. 7 is a diagram illustrating an interface for displaying feature information associated with an expected domain and an output domain according to an embodiment of the disclosure;

FIG. 8 is a graph illustrating a weight of classification information for each domain according to an embodiment of the disclosure;

FIGS. 9A and 9B are diagrams illustrating an interface for displaying a weight and frequency of feature information associated with a domain according to various embodiments of the disclosure;

FIG. 10 is a flowchart illustrating a method of analyzing a speech recognition result according to an embodiment of the disclosure;

FIG. 11 is a block diagram illustrating an integrated intelligence system according to an embodiment of the disclosure;

FIG. 12 is a diagram illustrating a form in which concept and action relationship information is stored in a database (DB) according to an embodiment of the disclosure; and

FIG. 13 is a diagram illustrating a screen showing that a user terminal processes a received voice input through an intelligent app according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

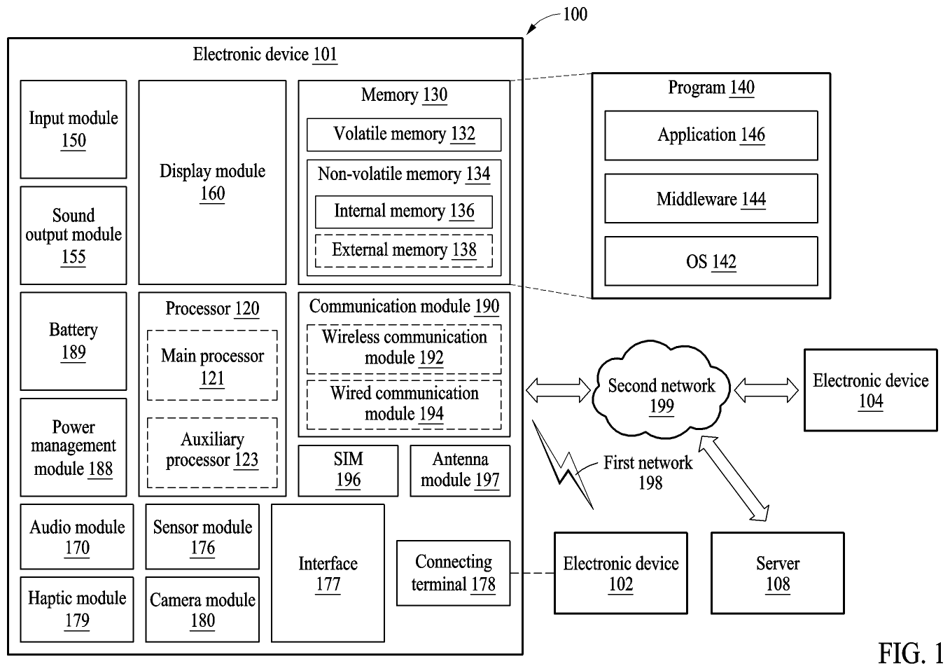

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or communicate with at least one of an electronic device 104 and a server 108 via a second network 199 (e.g., a long-range wireless communication network). According to an embodiment of the disclosure, the electronic device 101 may communicate with the electronic device 104 via the server 108. According to an embodiment of the disclosure, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one (e.g., the connecting terminal 178) of the above components may be omitted from the electronic device 101, or one or more other components may be added in the electronic device 101. In some embodiments of the disclosure, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment of the disclosure, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment of the disclosure, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display device 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment of the disclosure, the auxiliary processor 123 (e.g., an ISP or a CP) may be implemented as a portion of another component (e.g., the camera module 180 or the communication module 190) that is functionally related to the auxiliary processor 123. According to an embodiment of the disclosure, the auxiliary processor 123 (e.g., an NPU) may include a hardware structure specified for artificial intelligence model processing. An artificial intelligence model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The artificial intelligence model may additionally or alternatively, include a software structure other than the hardware structure.

The memory 130 may store various data used by at least one component (e.g., the processor 120 or the sensor module 176) of the electronic device 101. The data may include, for example, software (e.g., the program 140) and input data or output data for a command related thereto. The memory 130 may include the volatile memory 132 or the non-volatile memory 134. The non-volatile memory 134 may include an internal memory 136 and an external memory 138.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing records. The receiver may be used to receive an incoming call. According to an embodiment of the disclosure, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to an embodiment of the disclosure, the display module 160 may include a touch sensor adapted to sense a touch, or a pressure sensor adapted to measure an intensity of a force incurred by the touch.

The audio module 170 may convert a sound into an electric signal or vice versa. According to an embodiment of the disclosure, the audio module 170 may obtain the sound via the input module 150 or output the sound via the sound output module 155 or an external electronic device (e.g., an electronic device 102, such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment of the disclosure, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an embodiment of the disclosure, the haptic module 179 may include, for example, a motor, a piezoelectric element, or an electric stimulator.

The camera module 180 may capture a still image and moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as, for example, at least a part of a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel The communication module 190 may include one or more communication processors that are operable independently of the processor 120 (e.g., an AP) and that support a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5^{th} generation (5G) network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large scale antenna. The wireless communication module 192 may support various requirements specified in the electronic device 101, an external electronic device (e.g., the electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment of the disclosure, another component (e.g., a radio frequency integrated circuit (RFIC)) other than the radiating element may be additionally formed as a part of the antenna module 197.

According to various embodiments of the disclosure, the antenna module 197 may form a mmWave antenna module. According to an embodiment of the disclosure, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an embodiment of the disclosure, all or some of operations to be executed by the electronic device 101 may be executed at one or more of the external electronic devices 102, 104, and 108. For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

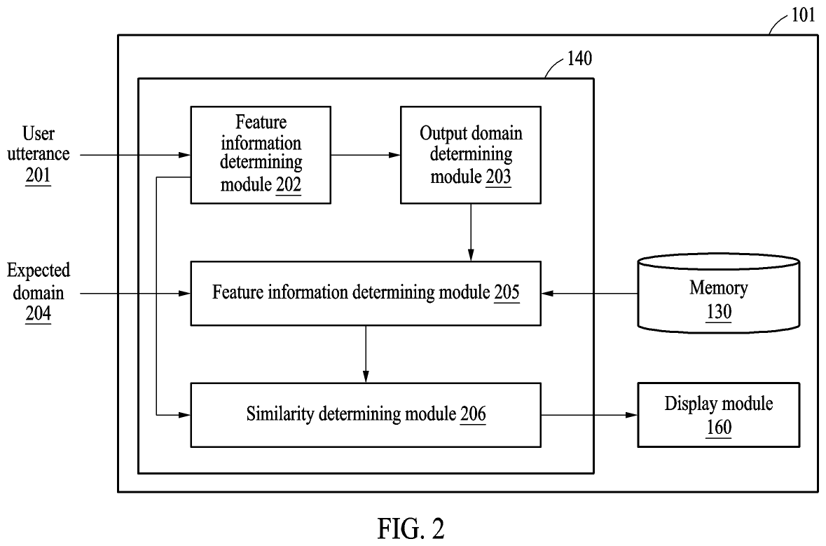

FIG. 2 is a block diagram illustrating an of a speech recognition result analyzing module in an electronic device according to an embodiment of the disclosure.

Referring to FIG. 2, operations processed in modules 202, 203, 205, and 206 illustrated in FIG. 2 may be performed by the processor 120. A user utterance 201 may be received through an input module (e.g., the input module 150 of the electronic device 101). The user utterance 201 may be converted into a text through an automatic speech recognition (ASR) module.

A method of converting the user utterance 201 into the text through the ASR module may not be limited to a particular example method, but various methods that may be readily adopted by those skilled in the art may be used.

Referring to FIG. 2, a feature information determining module 202 may generate feature information from a text corresponding to the user utterance 201. The feature information may include at least one of classification information, text information, and length information of words included in a single sentence, and previous utterance information.

The text information may be information associated with a text of a single word. The classification information may be information representing semantics of the text information. The classification information may indicate whether the text information is associated with a place, a time, a restaurant, a postposition, a human, an object, or the like.

The length information may be information associated with a length of a single sentence. The length information may be classified based on a plurality of reference ranges. For example, when a length of the text corresponding to the user utterance 201 is 10 and a reference range is from 5 to 15, the length information of the text corresponding to the user utterance 201 may be determined to be “medium.” The previous utterance information may be, when there is a previously recognized user utterance (e.g., the user utterance 201), information associated with a keyword or a context of the previously recognized user utterance.

The feature information determining module 202 may classify the text corresponding to the user utterance 201 by token information. The token information may represent a word-unit text constituting a sentence.

The feature information determining module 202 may classify the text corresponding to the user utterance 201 by the token information based on token information previously stored in the memory 130. The feature information determining module 202 may classify the text corresponding to the user utterance 201 by the token information by comparing the text corresponding to the user utterance 201 and the token information previously stored in the memory 130.

The feature information determining module 202 may extract the feature information from the text corresponding to the user utterance 201 by comparing the text corresponding to the user utterance 201 and feature information previously stored in the memory 130.

The feature information determining module 202 may generate the feature information of the text corresponding to the user utterance 201 by classifying the text corresponding to the user utterance 201 by the token information and extracting feature information associated with the token information of the text corresponding to the user utterance 201 from the feature information stored in the memory 130.

The memory 130 may store, by each domain, sentences used for training an artificial intelligence (AI) model and store feature information of each of the sentences. Thus, a plurality of pieces of feature information may be classified and stored by each domain, and the same feature information may be included in some domains.

An output domain determining module 203 may determine an output domain from the feature information of the text corresponding to the user utterance 201. The output domain may be a domain that is associated with the user utterance 201 or processes the user utterance 201. The output domain determining module 203 may determine the output domain through a natural language processing process performed on the user utterance 201.

For example, when the text corresponding to the user utterance 201 is “Find hotels nearby Seoul,” the feature information determining module 202 may classify the text corresponding to the user utterance 201 into a plurality of pieces of token information, for example, “Find,” “hotels,” “nearby,” and “Seoul.” The feature information determining module 202 may determine feature information (e.g., [text: find], [text: hotels], [text: nearby], [location: Seoul], [length: medium]) based on each of the pieces of the token information.

The output domain determining module 203 may determine the output domain using the feature information. For example, when the text corresponding to the user utterance 201 is “Find hotels nearby Seoul,” the output domain determining module 203 may determine, to be the output domain, a domain that processes a search for hotels through natural language processing.

The output domain determining module 203 may determine the output domain from the feature information of the text corresponding to the user utterance 201, using a learning model trained to determine the output domain from the text corresponding to the user utterance 201.

The learning model that determines the output domain from the text corresponding to the user utterance 201 may be a deep learning-based neural network model, which may be a rule-based model or a neural network model (e.g., a feedforward neural network (FNN), a recurrent neural network (RNN), and a convolutional neural network (CNN)). However, the learning model is limited to a particular example model, but various methods that may be readily adopted by those skilled in the art may be used.

A feature information determining module 205 may identify an expected domain 204 that is determined by a user. The expected domain 204 may be a domain intended by the user with the user utterance 201, and be input through the input module 150 (e.g., a keyboard) or the display module 160 including a touch sensor.

The feature information determining module 205 may extract prestored feature information associated with each of the expected domain 204 and the output domain. The feature information determining module 205 may extract, from the memory 130, prestored sentences for the same domain as the expected domain 204 and pieces of feature information of the sentences. The feature information determining module 205 may extract, from the memory 130, prestored sentences for the same domain as the output domain and pieces of feature information of the sentences.

A similarity determining module 206 may calculate a first similarity between the feature information associated with the output domain and the feature information of the text corresponding to the user utterance 201 and a second similarity between the feature information associated with the expected domain 204 and the feature information of the text corresponding to the user utterance 201. A similarity described herein may be a numerical value indicating a degree of similarity between pieces of feature information.

The similarity determining module 206 may determine the first similarity for each of pieces of the feature information associated with the output domain. For example, the similarity determining module 206 may determine the first similarity by comparing classification information included in the feature information of the text and classification information included in the feature information associated with the output domain.

The similarity determining module 206 may determine the first similarity of the feature information associated with the output domain, based on the number of pieces of the classification information included in the feature information associated with the output domain that is the same as the classification information included in the feature information of the text corresponding to the user utterance 201.

The similarity determining module 206 may determine the second similarity for each of pieces of the feature information associated with the expected domain 204. For example, the similarity determining module 206 may determine the second similarity by comparing the classification information included in the feature information of the text and the pieces of the classification information included in the feature information associated with the expected domain 204.

The similarity determining module 206 may determine the second similarity of the feature information associated with the expected domain 204, based on the number of pieces of the classification information included in the feature information associated with the expected domain 204 that is the same as the classification information included in the feature information of the text corresponding to the user utterance 201.

According to an embodiment of the disclosure, the similarity determining module 206 may determine the first similarity and the second similarity using Equation 1 below.

$$J ( A , B ) = \frac{\vert A ⋂ B \vert}{\vert A ⋃ B \vert} \qquad Equation 1$$

In Equation 1, A denotes a set of pieces of information (e.g., at least one of classification information and length information) included in the feature information associated with the output domain or the expected domain 204. B denotes a set of pieces of information (e.g., at least one of classification information and length information) included in the feature information of the text corresponding to the user utterance 201. J(A, B) denotes a similarity between A and B.

The similarity determining module 206 may determine the first similarity or the second similarity based on the pieces of the common information between the pieces of the information included in the feature information of the text corresponding to the user utterance 201 and the pieces of the information included in the feature information associated with the output domain or the expected domain 204.

The similarity determining module 206 may determine the first similarity or the second similarity based on a weight of each of the classification information, the text information, the length information, and the previous utterance information included in the feature information associated with the output domain and the feature information associated with the expected domain 204.

For example, a value of the first similarity determined in a case where classification information having a high weight in the classification information included in the feature information associated with the output domain is the same as the classification information included in the feature information of the text corresponding to the user utterance 201 may be determined to be greater than a value of the first similarity determined in a case where classification information having a low weight in the classification information included in the feature information associated with the output domain is the same as the classification information included in the feature information of the text corresponding to the user utterance 201.

The weight may be determined in advance for each of pieces of feature information stored in the memory 130. The weight may be determined differently for each domain even for the same feature information. The weight may be determined to have a high value for higher association with a domain. The weight of feature information for each domain may be determined in advance by a user.

According to an embodiment of the disclosure, a greater weight may be determined for classification information included in feature information associated with a domain that has a higher frequency of being included in the feature information. According to an embodiment of the disclosure, a greater weight may be determined for text information included in feature information associated with a domain that has a higher frequency of being included in the feature information.

According to an embodiment of the disclosure, the feature information associated with the output domain and the feature information associated with the expected domain 204 may be included in the display module 160. The first similarity of the feature information associated with the output domain or the second similarity of the feature information associated with the expected domain 204 may be displayed on the display module 160.

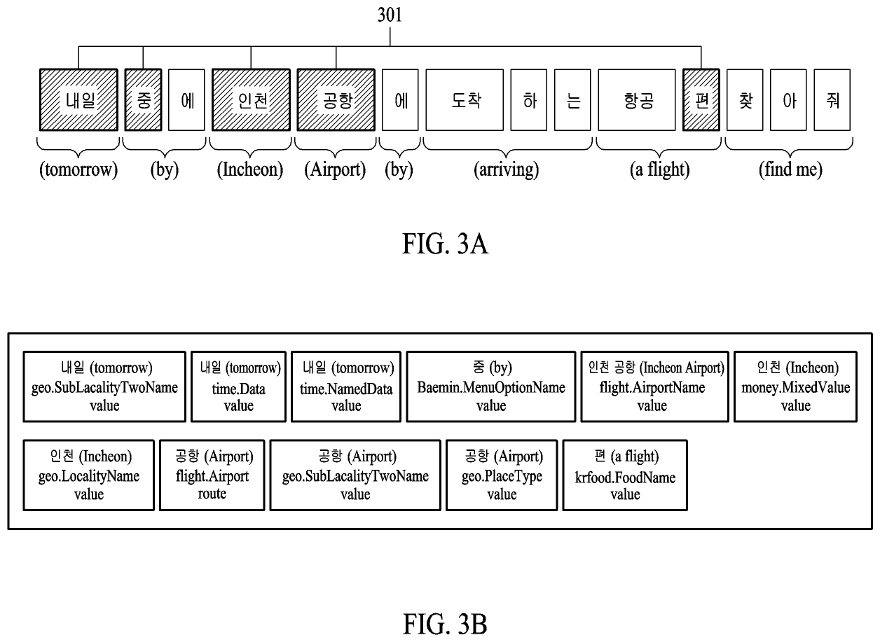

FIGS. 3A and 3B are diagrams illustrating an of a text corresponding to a user utterance and classification information of the text according to various embodiments.

FIG. 3A illustrates a user utterance (e.g., the user utterance 201 of FIG. 2) being converted into a text through ASR and classified into pieces of token information 301 according to an embodiment of the disclosure.

FIG. 3B illustrates classification information extracted based on the token information 301 illustrated in FIG. 3A according to an embodiment of the disclosure.

Referring to FIG. 3A, for example, when the text corresponding to the user utterance is “ [symbol] [symbol] ”(or “find me a flight to Incheon Airport arriving by tomorrow” in English), the token information 301 may include “ [symbol] ” “ [symbol] ” “ [symbol] ” “ [symbol] ” “ [symbol] ” “ [symbol] ” “ [symbol] ” “ [symbol] ” “ [symbol] ” “ [symbol] ” “ [symbol] ” “ [symbol] ” “ [symbol] ”and “ [symbol] ”.

For each piece of the token information 301, classification information previously stored in the memory 130 may be extracted. Referring to FIG. 3B, for example, for “ [symbol] ” (or “airport” in English), a place (e.g., geo.PlaceType) and an airport (e.g., flight.Airport) may be determined as classification information.

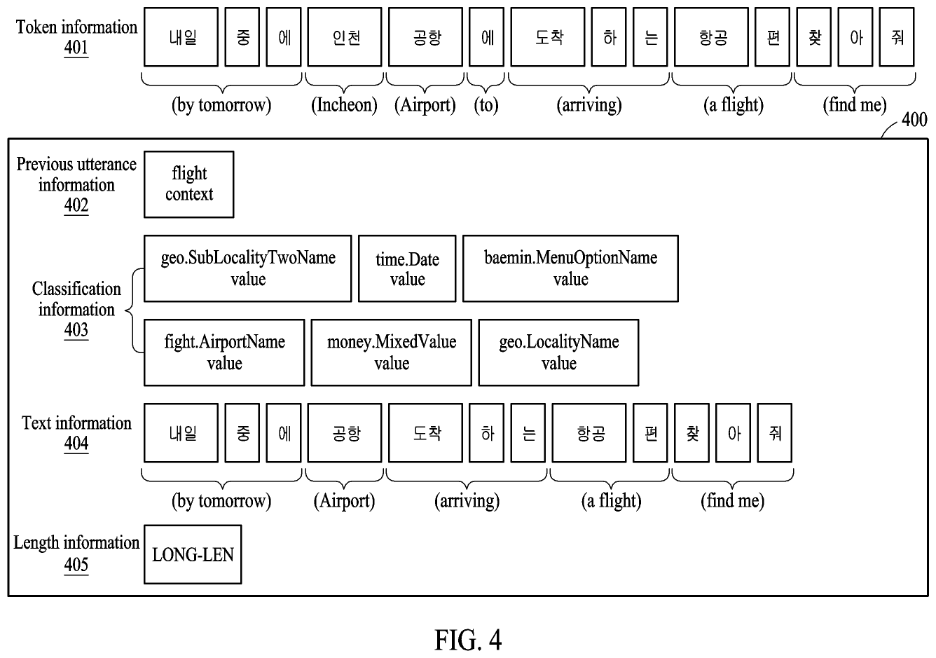

FIG. 4 is a diagram 400 illustrating feature information of a text corresponding to a user utterance according to an embodiment of the disclosure.

Referring to FIG. 4, it illustrates token information 401 of a text corresponding to a user utterance (e.g., the user utterance 201 of FIG. 2) and feature information of the text corresponding to the user utterance. The token information 401 may include “ [symbol] ” “ [symbol] ” “ [symbol] ” “ [symbol] ” “ [symbol] ” “ [symbol] ” “ [symbol] ” “ [symbol] ” “ [symbol] ” “ [symbol] ” “ [symbol] ” “ [symbol] ” “ [symbol] ” and “ [symbol] ”.

Previous utterance information 402 may be information associated with a keyword or a context of a previously recognized user utterance. Referring to FIG. 4, for example, when the previously recognized user utterance is an utterance associated with a flight, the previous utterance information 402 may be a flight context. When the user utterance is input, the processor 120 may perform natural language processing and update the previous utterance information 402.

Classification information 403 may be information representing semantics of the token information 401. The classification information 403 of the text corresponding to the user utterance may be determined based on the classification information 403 stored in advance for each piece of the token information 401 in the memory 130. Text information 404 may be information associated with the text corresponding to the user utterance. The text information 404 may include the token information 401.

Length information 405 may be information representing a length of the text corresponding to the user utterance. When the length of the text corresponding to the user utterance is in a reference range, an index corresponding to the reference range may be determined to be the length information 405. For example, when the length of the text is 10 or greater and 20 or less, the length information 405 may be determined to be “high” (e.g., LONG-LEN).

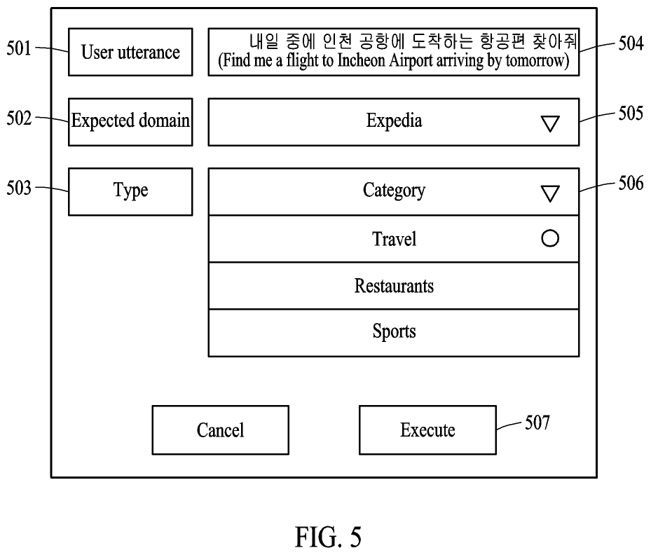

FIG. 5 is a diagram illustrating an interface for inputting an expected domain according to an embodiment of the disclosure.

Referring to FIG. 5, a user may input an expected domain 502 intended by the user through a graphical user interface (GUI). The GUI may be displayed by the display module 160 of the electronic device 101. The GUI may include a text 504 corresponding to a user utterance 501 (e.g., the user utterance 201 of FIG. 2) recognized through ASR.

According to an embodiment of the disclosure, a user may select or input the expected domain 502 (e.g., the expected domain 204 of FIG. 2) on an interface. Referring to FIG. 5, the user may select the expected domain 502, directly input the expected domain 502, or input by uttering the expected domain 502, using an input interface 505.

The GUI may include an input interface 506 for selecting a type 503 of the expected domain 502. The user may determine a type 503 of the user utterance 501 through the input interface 506. When the type 503 of the user utterance 501 is determined, the processor 120 may extract feature information including classification information associated with the type 503 of the user utterance 501 among pieces of classification information of the expected domain 502.

For example, as illustrated in FIG. 5, when the expected domain 502 is determined to be “Expedia” which is a flight reservation application and the type 503 is determined to be “travel” for the user utterance 501, for example, “ [symbol] [symbol] ” or “find me a flight to Incheon Airport arriving by tomorrow” in English), the processor 120 may extract feature information associated with Expedia and extract feature information including classification information associated with travel from the feature information.

When an execute button 507 of the GUI illustrated in FIG. 5 is input, the processor 120 may extract sentences previously stored for the expected domain 502 and pieces of feature information, for the expected domain 502. The processor 120 may determine feature information having a greatest similarity by comparing the extracted pieces of the feature information and the pieces of the feature information extracted from the user utterance 501.

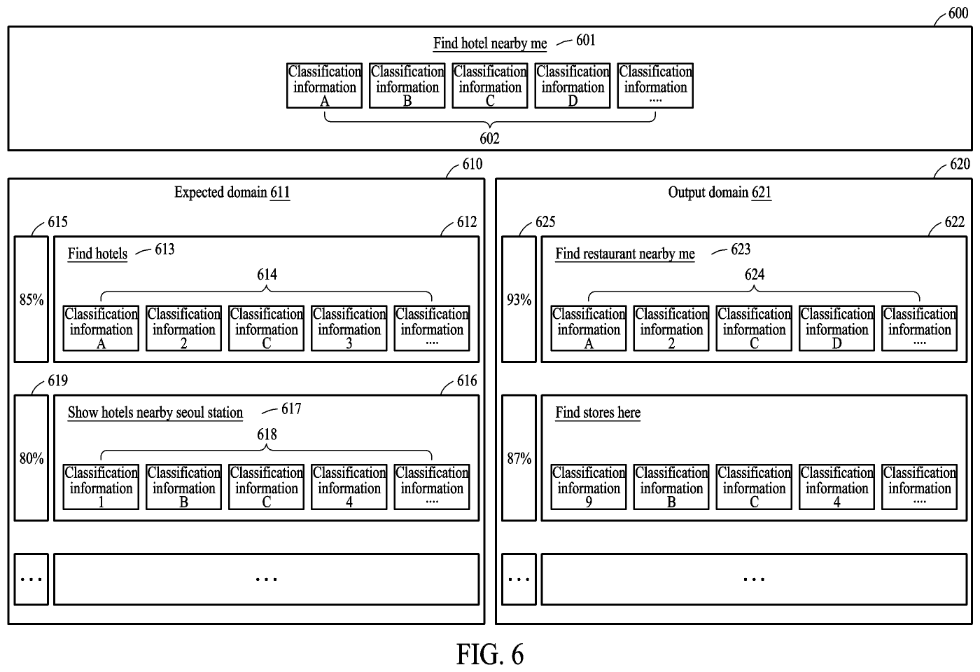

FIG. 6 is a diagram illustrating an interface for displaying feature information of an expected domain and an output domain according to an embodiment of the disclosure.

Referring to FIG. 6, a developer may analyze feature information that affects an output of a learning model that performs natural language processing by verifying, through a GUI, feature information having a high similarity to feature information of a user utterance (e.g., the user utterance 201 of FIG. 2) in feature information associated with an output domain 621 determined by the learning model and feature information having a high similarity to the feature information of the user utterance in feature information associated with an expected domain 611 (e.g., the expected domain 204 of FIG. 2).

The GUI of FIG. 6 may be displayed by the display module 160 of the electronic device 101, and include an interface 600 for the user utterance, an interface 610 for the expected domain 611, and an interface 620 for the output domain 621. Pieces of data included in the GUI of FIG. 6 may be arranged in various forms, and examples thereof are not limited to the illustrated example.

According to an embodiment of the disclosure, on the GUI of FIG. 6, the interface 610 for the expected domain 611 may not be displayed but displayed as shown in the interface 620 for the output domain 621 through a separate input process.

Referring to FIG. 6, the interface 600 for the user utterance may include a text 601 corresponding to the user utterance, and classification information 602 determined based on the text 601 corresponding to the user utterance. The interface 600 for the user utterance may include feature information other than classification information of the text 601 corresponding to the user utterance.

The interface 610 for the expected domain 611 may include the expected domain 611 determined by a user. The interface 610 for the expected domain 611 may include feature information 612 and feature information 616 associated with the expected domain 611. The interface 610 for the expected domain 611 may include second similarities 615 and 619 between the feature information 612 and the feature information of the text 601 corresponding to the user utterance and between the feature information 616 and the feature information of the text 601 corresponding to the user utterance, respectively.

The feature information 612 and 616 displayed on the interface 610 for the expected domain 611 may be feature information having highest second similarities (e.g., the second similarities 615 and 619) to the feature information of the text 601 corresponding to the user utterance in feature information stored in advance for the expected domain 611. The processor 120 may display, on the display module 160, the feature information 612 and 616 in an order of the feature information having the highest second similarities 615 and 619 to the feature information of the text 601 corresponding to the user utterance in the feature information associated with the expected domain 611.

The feature information 612 may include a sentence 613 corresponding to the feature information 612, and classification information 614. For classification information that is more highly associated with the expected domain 611 in classification information of the feature information associated with the expected domain 611, a greater weight may be determined. The processor 120 may display, on the display module 160, classification information having a greater weight than a reference in the classification information included in the domain-related feature information such that it is identifiable from other classification information.

For example, the processor 120 may display the classification information 614 having the higher weight by increasing a shade of the classification information 614, such that the magnitude of the weight is identifiable. The feature information 616 may include a sentence 617 corresponding to the feature information 616, and classification information 618.

Feature information 622 displayed on the interface 620 for the output domain 621 may be feature information having a highest first similarity 625 to the feature information of the text 601 corresponding to the user utterance in feature information previously stored for the output domain 621. The processor 120 may display, on the display module 160, feature information in an order of feature information having a highest first similarity (e.g., the highest first similarity 625) to the feature information of the text 601 corresponding to the user utterance in the feature information associated with the output domain 621.

The feature information 622 may include a sentence 623 corresponding to the feature information 622, and classification information 624. For classification information that is more highly associated with the output domain 621 in the feature information associated with the output domain 621, a greater weight may be determined. The processor 120 may display, on the display module 160, classification information having a weight greater than a reference in the classification information 624 included in the domain-related feature information such that it is identifiable from other classification information.

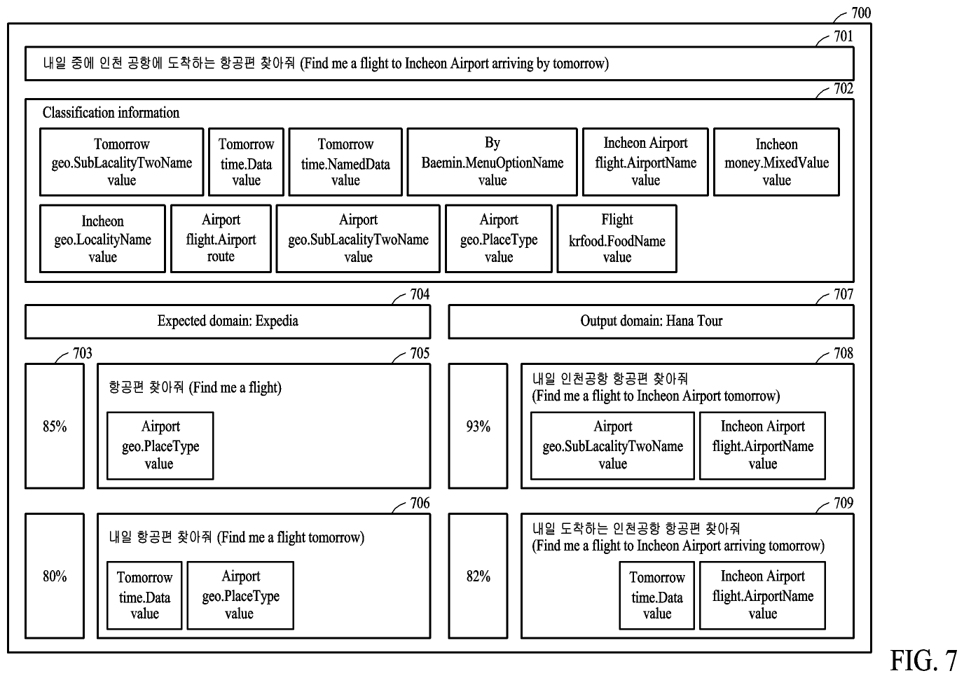

FIG. 7 is a diagram illustrating an interface for displaying feature information of an expected domain and an output domain according to an embodiment of the disclosure.

Referring to FIG. 7, a GUI 700 illustrated in FIG. 7 may be displayed through the display module 160. Referring to FIG. 7, the GUI 700 may display at least one of a text 701 corresponding to a user utterance, feature information 702 extracted from the text 701 corresponding to the user utterance, an expected domain 704, feature information 705 and 706 associated with the expected domain 704 in feature information associated with the expected domain 704 that has a similarity greater than or equal to a reference to the feature information 702, an output domain 707, and feature information 708 and 709 associated with the output domain 707 in feature information associated with the output domain 707 that has a similarity greater than or equal to a reference to the feature information 702.

For example, when the text 701 corresponding to the user utterance is “ [symbol] [symbol] ” (or “find a flight to Incheon Airport arriving by tomorrow” in English) as illustrated in FIG. 7, classification information 702 associated with “ [symbol] ” (tomorrow), “ [symbol] ” (Incheon), “ [symbol] ” (airport), and “ [symbol] ” (flight) may be extracted as the feature information 702. The expected domain 704 of a user may be “Expedia,” and the output domain 707 determined by a learning model may be “Hana Tour.”

The processor 120 may display, through the display module 160, the feature information 705, 706, 708, and 709 having the highest similarities to the user utterance in feature information previously stored as learning data of the learning model for the expected domain 704 and the output domain 707, and may thus allow a developer to analyze which feature information affects the learning model in outputting the output domain 707 instead of the expected domain 704.

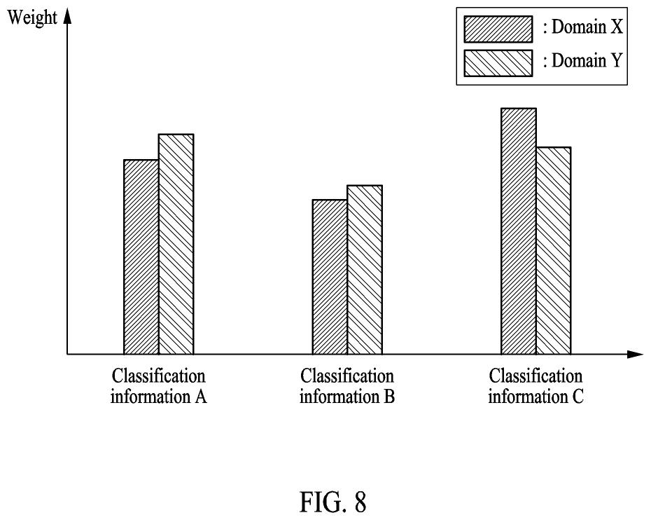

FIG. 8 is a graph illustrating a weight of classification information for each domain according to an embodiment of the disclosure.

Referring to FIG. 8, the processor 120 may display, in a graph, how weights of classification information stored in advance in the memory 130 are determined for each domain through the display module 160. The processor 120 may determine a weight of feature information, such as classification information, according to a user guideline or frequency for each domain.

The processor 120 may extract a domain-specific weight of the stored classification information, and display the weight by the graph on the display module 160. Referring to FIG. 8, for example, a weight of classification information, such as ‘travel,’ ‘date,’ and ‘hotels’ may be determined to be greater for a flight or accommodation reservation-related domain than for a finance-related domain. A developer may verify how weights of classification information are determined by each domain by referring to the graph illustrated in FIG. 8.

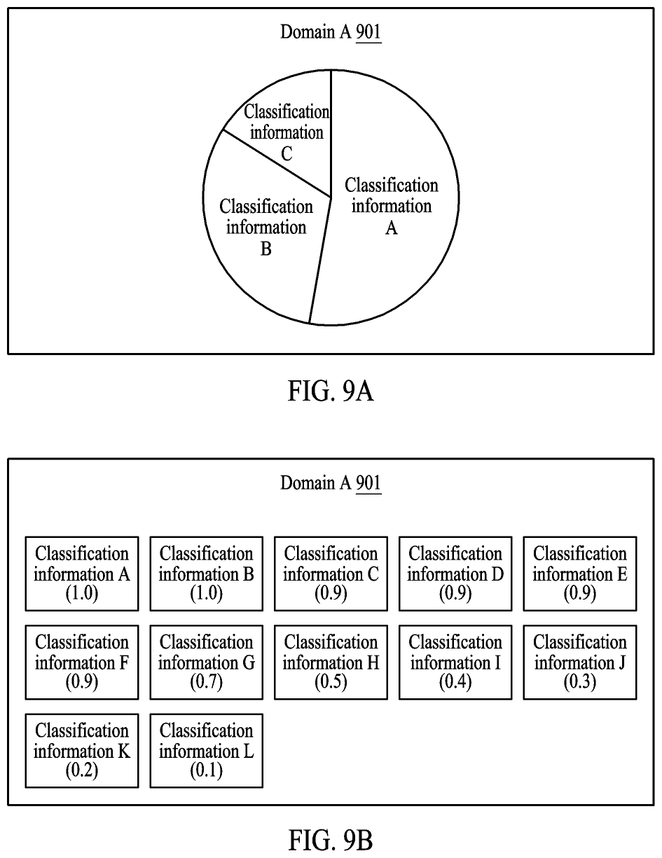

FIGS. 9A and 9B are diagrams illustrating an interface displaying a weight and frequency of feature information associated with a domain according to various embodiments of the disclosure.

FIGS. 9A and 9B illustrate pieces of classification information included in feature information previously stored for a domain A 901 and a graph of a frequency of each of the pieces of the classification information. The feature information may be pieces of feature information associated with the domain A 901 and be stored in advance in the memory 130.

Referring to FIG. 9A, the graph represents the frequency of each piece of classification information included in sentences associated with the domain A 901. Referring to FIG. 9A, the graph represents the frequency of each piece of classification information included in sentences associated with the domain A 901.

FIG. 9B illustrates the pieces of the classification information associated with the domain A 901 and respective weights of the pieces of the classification information associated with the domain A 901. The processor 120 may extract classification information previously stored for a domain and a weight of the classification information, and display a frequency or the weight of the classification information through the display module 160.

A developer may analyze a piece of the classification information that is most frequently included in learning data, and a piece of the classification information that has a weight determined to be highest.

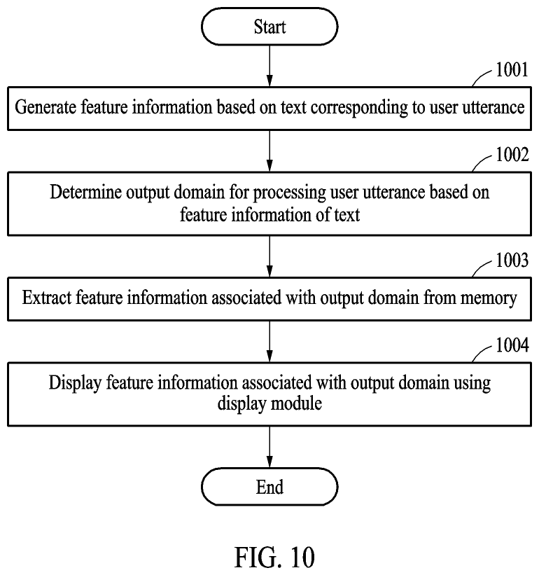

FIG. 10 is a flowchart illustrating a method of analyzing a speech recognition result according to an embodiment of the disclosure.

Referring to FIG. 10, in operation 1001, the processor 120 may generate feature information based on a text corresponding to a user utterance. The processor 120 may obtain the text corresponding to the user utterance by converting the received user utterance into the text through ASR. The processor 120 may determine the feature information of the text corresponding to the user utterance based on feature information previously stored in the memory 130.

In operation 1002, the processor 120 may determine an output domain for processing the user utterance based on the feature information of the text. The processor 120 may determine the output domain by inputting the feature information of the text corresponding to the user utterance to a learning model trained to determine a domain for processing the user utterance from the text.

In operation 1003, the processor 120 may extract feature information associated with the output domain from the memory 130. The memory 130 may store feature information used for training the learning model for each domain. The processor 120 may extract feature information previously stored for the output domain from the memory 130. The processor 120 may identify an expected domain determined by a user, and extract feature information previously stored for the expected domain from the memory 130.

In operation 1004, the processor 120 may display the feature information associated with the output domain using the display module 160. The processor 120 may display, on the display module 160, at least one of the text corresponding to the user utterance, the feature information of the text corresponding to the user utterance, the feature information associated with the output domain, the feature information associated with the expected domain, a first similarity between the feature information associated with the output domain and the feature information of the text corresponding to the user utterance, and a second similarity between the feature information associated with the expected domain and the feature information of the text corresponding to the user utterance.

The processor 120 may display the feature information associated with the output domain in an order of feature information having a highest value in the first similarity, and display the feature information associated with the expected domain in an order of feature information having a highest second similarity. The processor 120 may display, on the display module 160, classification information having a weight greater than a reference in classification information included in the feature information associated with the output domain or the expected domain.

The processor 120 may extract the feature information associated with the output domain without separately receiving the expected domain from the user, determine feature information having a high first similarity to the feature information of the text corresponding to the user utterance in the feature information associated with the output domain, and display the determined feature information on the display module 160. The processor 120 may determine the first similarity based on a weight predetermined for information included in the feature information.

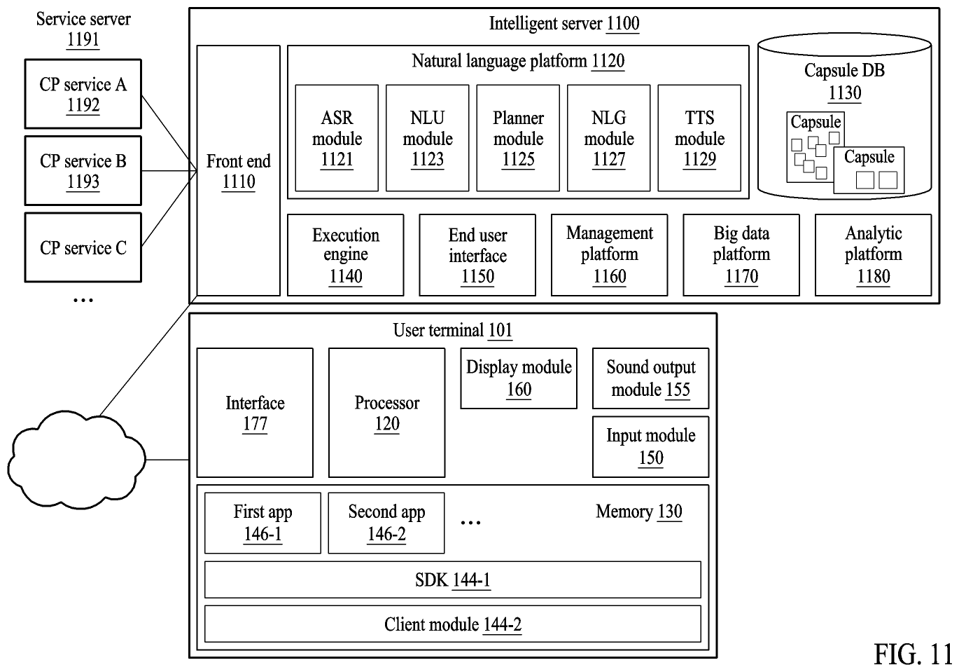

FIG. 11 is a block diagram illustrating an integrated intelligence system according to an embodiment of the disclosure.

Referring to FIG. 11, according to an embodiment of the disclosure, an integrated intelligence system may include a user terminal 101, an intelligent server 1100, and a service server 1191 including CP service A 1192, CP service B 1193, and CP service C.

The user terminal 101 may be a terminal device (or an electronic device) connectable to the Internet, and may be, for example, a mobile phone, a smartphone, a personal digital assistant (PDA), a laptop computer, a television (TV), a white home appliance, a wearable device, a head-mounted display (HMD), or a smart speaker.

As illustrated, the user terminal 101 may include an interface 177, an input module 150, a sound output module 155, a display module 160, a memory 130, or a processor 120. The components listed above may be operationally or electrically connected to each other.

The interface 177 may be connected to an external device and configured to transmit and receive data to and from the external device. The input module 150 may receive a sound (e.g., a user utterance) and convert the sound into an electrical signal. The sound output module 155 may output the electrical signal as a sound (e.g., a voice or speech). The display module 160 may be configured to display an image or video. The display module 160 may also display a GUI of an app (or an application program) being executed.

The memory 130 may store a client module 144-2, a software development kit (SDK) 144-1, and a plurality of apps 146. The client module 144-2 and the SDK 144-1 may configure a framework (or a solution program) for performing general-purpose functions. In addition, the client module 144-2 or the SDK 144-1 may configure a framework for processing a voice input.

The apps 146 may be programs for performing designated functions. The apps 146 may include a first app 146-1, a second app 146-2, and the like. Each of the apps 146 may include a plurality of actions for performing a designated function. For example, the apps 146 may include an alarm app, a message app, and/or a scheduling app. The apps 146 may be executed by the processor 120 to sequentially execute at least a portion of the actions.

The processor 120 may control the overall operation of the user terminal 101. For example, the processor 120 may be electrically connected to the interface 177, the input module 150, the sound output module 155, and the display module 160 to perform a designated operation.

The processor 120 may also perform the designated function by executing the program stored in the memory 130. For example, the processor 120 may execute at least one of the client module 144-2 or the SDK 144-1 to perform the following operations for processing a voice input. The processor 120 may control the actions of the apps 146 through, for example, the SDK 144-1. The following operations described as operations of the client module 144-2 or the SDK 144-1 may be operations by the execution by the processor 120.

The client module 144-2 may receive a voice input. For example, the client module 144-2 may receive a voice signal corresponding to a user utterance sensed through the input module 150. The client module 144-2 may transmit the received voice input to the intelligent server 1100. The client module 144-2 may transmit state information of the user terminal 101 together with the received voice input to the intelligent server 1100. The state information may be, for example, execution state information of an app.

The client module 144-2 may receive a result corresponding to the received voice input. For example, when the intelligent server 1100 is capable of calculating a result corresponding to the received voice input, the client module 144-2 may receive the result corresponding to the received voice input. The client module 144-2 may display the received result on the display module 160.

The client module 144-2 may receive a plan corresponding to the received voice input. The client module 144-2 may display, on the display module 160, results of executing a plurality of actions of an app according to the plan. The client module 144-2 may, for example, sequentially display the results of executing the actions on the display module 160. As another example, the user terminal 101 may display only a partial result of executing the actions (e.g., a result of the last action) on the display module 160.

According to an embodiment of the disclosure, the client module 144-2 may receive a request for obtaining information necessary for calculating a result corresponding to the voice input from the intelligent server 1100. According to an embodiment of the disclosure, the client module 144-2 may transmit the necessary information to the intelligent server 1100 in response to the request.

The client module 144-2 may transmit information on the results of executing the actions according to the plan to the intelligent server 1100. The intelligent server 1100 may confirm that the received voice input has been correctly processed using the information on the results.

The client module 144-2 may include a speech recognition module. According to an embodiment of the disclosure, the client module 144-2 may recognize a voice input for performing a limited function through the speech recognition module. For example, the client module 144-2 may execute an intelligent app for processing a voice input to perform an organic action through a designated input (e.g., Wake up!).

The intelligent server 1100 may receive information related to a user voice input from the user terminal 101 through a communication network. According to an embodiment of the disclosure, the intelligent server 1100 may change data related to the received voice input into text data. According to an embodiment of the disclosure, the intelligent server 1100 may generate a plan for performing a task corresponding to the user voice input based on the text data.

According to an embodiment of the disclosure, the plan may be generated by an artificial intelligence (AI) system. The artificial intelligence system may be a rule-based system or a neural network-based system (e.g., a feedforward neural network (FNN) or a recurrent neural network (RNN)). Alternatively, the artificial intelligence system may be a combination thereof or other artificial intelligence systems. According to an embodiment of the disclosure, the plan may be selected from a set of predefined plans or may be generated in real time in response to a user request. For example, the artificial intelligence system may select at least one plan from among the predefined plans.

The intelligent server 1100 may transmit a result according to the generated plan to the user terminal 101 or transmit the generated plan to the user terminal 101. According to an embodiment of the disclosure, the user terminal 101 may display the result according to the plan on the display module 160. According to an embodiment of the disclosure, the user terminal 101 may display a result of executing an action according to the plan on the display module 160.

The intelligent server 1100 may include a front end 1110, a natural language platform 1120, a capsule database (DB) 1130, an execution engine 1140, an end user interface 1150, a management platform 1160, a big data platform 1170, or an analytic platform 1180.

The front end 1110 may receive a voice input from the user terminal 101. The front end 1110 may transmit a response corresponding to the voice input.

According to an embodiment of the disclosure, the natural language platform 1120 may include an ASR module 1121, a natural language understanding (NLU) module 1123, a planner module 1125, a natural language generator (NLG) module 1127, or a text-to-speech (TTS) module 1129.

The ASR module 1121 may convert the voice input received from the user terminal 101 into text data. The NLU module 1123 may discern an intent of a user using the text data of the voice input. For example, the NLU module 1123 may discern the intent of the user by performing a syntactic analysis or semantic analysis. The NLU module 1123 may discern the meaning of a word extracted from the voice input using a linguistic feature (e.g., a grammatical element) of a morpheme or phrase, and determine the intent of the user by matching the discerned meaning of the word to the intent.

The planner module 1125 may generate a plan using a parameter and the intent determined by the NLU module 1123. According to an embodiment of the disclosure, the planner module 1125 may determine a plurality of domains required to perform a task based on the determined intent. The planner module 1125 may determine a plurality of actions included in each of the domains determined based on the intent. According to an embodiment of the disclosure, the planner module 1125 may determine a parameter required to execute the determined actions or a result value output by the execution of the actions. The parameter and the result value may be defined as a concept of a designated form (or class). Accordingly, the plan may include a plurality of actions and a plurality of concepts determined by the intent of the user. The planner module 1125 may determine a relationship between the actions and the concepts stepwise (or hierarchically). For example, the planner module 1125 may determine an execution order of the actions determined based on the intent of the user, based on the concepts. In other words, the planner module 1125 may determine the execution order of the actions based on the parameter required for the execution of the actions and results output by the execution of the actions. Accordingly, the planner module 1125 may generate the plan including connection information (e.g., ontology) between the actions and the concepts. The planner module 1125 may generate the plan using information stored in the capsule DB 1130 that stores a set of relationships between concepts and actions.

The NLG module 1127 may change designated information into a text form. The information changed to the text form may be in the form of a natural language utterance. The TTS module 1129 may change information in a text form into information in a speech form.

According to an embodiment of the disclosure, some or all of the functions of the natural language platform 1120 may also be implemented in the user terminal 101.

The capsule DB 1130 may store information on relationships between a plurality of concepts and a plurality of actions corresponding to a plurality of domains. According to an embodiment of the disclosure, a capsule may include a plurality of action objects (or action information) and concept objects (or concept information) included in a plan. According to an embodiment of the disclosure, the capsule DB 1130 may store a plurality of capsules in the form of a concept action network (CAN). According to an embodiment of the disclosure, the capsules may be stored in a function registry included in the capsule DB 1130.

The capsule DB 1130 may include a strategy registry that stores strategy information necessary for determining a plan corresponding to a voice input. The strategy information may include reference information for determining one plan when there are a plurality of plans corresponding to the voice input. According to an embodiment of the disclosure, the capsule DB 1130 may include a follow-up registry that stores information on follow-up actions for suggesting a follow-up action to the user in a designated situation. The follow-up action may include, for example, a follow-up utterance. According to an embodiment of the disclosure, the capsule DB 1130 may include a layout registry that stores layout information of information output through the user terminal 101. According to an embodiment of the disclosure, the capsule DB 1130 may include a vocabulary registry that stores vocabulary information included in capsule information. According to an embodiment of the disclosure, the capsule DB 1130 may include a dialog registry that stores information on a dialog (or an interaction) with the user. The capsule DB 1130 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a currently set objective, a preference of the user, or an environmental condition. According to an embodiment of the disclosure, the capsule DB 1130 may also be implemented in the user terminal 101.

The execution engine 1140 may calculate a result using a generated plan. The end user interface 1150 may transmit the calculated result to the user terminal 101. Accordingly, the user terminal 101 may receive the result and provide the received result to the user. The management platform 1160 may manage information used by the intelligent server 1100. The big data platform 1170 may collect data of the user. The analytic platform 1180 may manage a quality of service (QoS) of the intelligent server 1100. For example, the analytic platform 1180 may manage the components and processing rate (or efficiency) of the intelligent server 1100.

The service server 1191 may provide a designated service (e.g., food order or hotel reservation) to the user terminal 101. According to an embodiment of the disclosure, the service server 1191 may be a server operated by a third party. The service server 1191 may provide the intelligent server 1100 with information to be used for generating a plan corresponding to a received voice input. The provided information may be stored in the capsule DB 1130. In addition, the service server 1191 may provide result information according to the plan to the intelligent server 1100.

In the integrated intelligence system described above, the user terminal 101 may provide various intelligent services to a user in response to a user input. The user input may include, for example, an input through a physical button, a touch input, or a voice input.

In an embodiment of the disclosure, the user terminal 101 may provide a speech recognition service through an intelligent app (or a speech recognition app) stored therein. In this case, for example, the user terminal 101 may recognize a user utterance or a voice input received through the input module 150, and provide a service corresponding to the recognized voice input to the user.

In an embodiment of the disclosure, the user terminal 101 may perform a designated action alone or together with the intelligent server 1110 and/or the service server 1191, based on a received voice input. For example, the user terminal 101 may execute an app corresponding to the received voice input and perform a designated action through the executed app.

In an embodiment of the disclosure, when the user terminal 101 provides a service together with the intelligent server 1100 and/or the service server 1191, the user terminal 101 may detect a user utterance using the input module 150 and generate a signal (or voice data) corresponding to the detected user utterance. The user terminal 101 may transmit the voice data to the intelligent server 1100 using the interface 177.

The intelligent server 1100 may generate, as a response to a voice input received from the user terminal 101, a plan for performing a task corresponding to the voice input or a result of performing an action according to the plan. The plan may include, for example, a plurality of actions for performing a task corresponding to a voice input of a user, and a plurality of concepts related to the actions. The concepts may define parameters input to the execution of the actions or result values output by the execution of the actions. The plan may include connection information between the actions and the concepts.

The user terminal 101 may receive the response using the interface 177. The user terminal 101 may output a speech signal generated in the user terminal 101 to the outside using the sound output module 155, or output an image generated in the user terminal 101 to the outside using the display module 160.

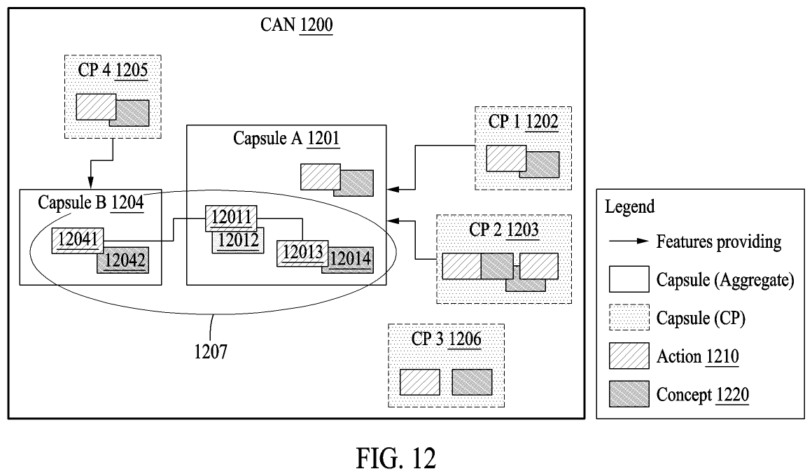

FIG. 12 is a diagram illustrating a form in which concept and action relationship information is stored in a DB according to an embodiment of the disclosure.

Referring to FIG. 12, a capsule DB (e.g., the capsule DB 1130) of the intelligent server 1100 may store therein a capsule in the form of a concept action network (CAN) 1200. The capsule DB may store, in the form of the CAN 1200, actions for processing a task corresponding to a voice input of a user and parameters necessary for the actions.

The capsule DB may store a plurality of capsules, for example, referring to FIG. 12, a capsule A 1201 and a capsule B 1204, respectively corresponding to a plurality of domains (e.g., applications) and at least one service provider (e.g., CP1 1205). According to an embodiment of the disclosure, one capsule (e.g., the capsule A 1201) may correspond to one domain (e.g., a location (geo) or an application). In addition, one capsule may correspond to at least one service provider (e.g., CP1 1202 or CP 1203) for performing a function for a domain related to the capsule. According to an embodiment of the disclosure, one capsule may include at least one action 1210 for performing a designated function and at least one concept 1220.

The natural language platform 1120 may generate a plan for performing a task corresponding to a received voice input using the capsule stored in the capsule DB. For example, the planner module 1125 of the natural language platform 1120 may generate the plan using the capsule stored in the capsule DB. For example, the planner module 1125 may generate a plan 1207 using actions 12011 and 12013 and concepts 12012 and 12014 of the capsule A 1201 and using an action 12041 and a concept 12042 of the capsule B 1204.

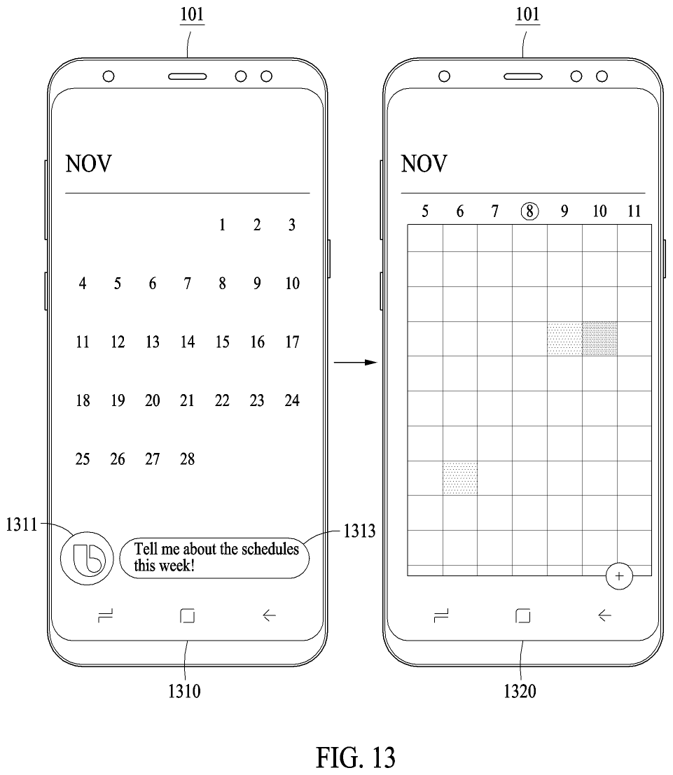

FIG. 13 is a diagram illustrating a screen showing that a user terminal processes a received voice input through an intelligent appl according to an embodiment of the disclosure.

The user terminal 101 may execute an intelligent app to process a user input through the intelligent server 1100.

Referring to FIG. 13, on a screen 1310, when a designated voice input (e.g., Wake up!) is recognized or an input through a hardware key (e.g., a dedicated hardware key) is received, the user terminal 101 may execute an intelligent app for processing the voice input. The user terminal 101 may execute the intelligent app, for example, while a scheduling app is being executed. According to an embodiment of the disclosure, the user terminal 101 may display an object (e.g., an icon) 1311 corresponding to the intelligent app on the display module 160. According to an embodiment of the disclosure, the user terminal 101 may receive a voice input by a user utterance. For example, the user terminal 101 may receive a voice input “Tell me about the schedules this week!.” According to an embodiment of the disclosure, the user terminal 101 may display a user interface (UI) 1313 (e.g., an input window) of the intelligent app in which text data of the received voice input is displayed.

According to an embodiment of the disclosure, on a screen 1320, the user terminal 101 may display a result corresponding to the received voice input on the display module 160. For example, the user terminal 101 may receive the plan corresponding to the received user input, and display “the schedules this week” according to the plan on the display module 160.

According to various embodiments of the disclosure, an electronic device 101 may include a display module 160 that provides information to the outside of the electronic device 101, a processor 120 electrically connected to the display module 160, and a memory 130 electrically connected to the processor 120. The processor 120 may generate feature information of a text corresponding to a user utterance based on the text, determine an output domain for processing the user utterance based on the feature information of the text, identify an expected domain predetermined by a user, extract feature information associated with the output domain and feature information associated with the expected domain from the memory 130, and display the feature information associated with the output domain and the feature information associated with the expected domain using the display module 160.

The processor 120 may determine a first similarity between the feature information of the text and the feature information associated with the output domain and a second similarity between the feature information of the text and the feature information associated with the expected domain, and display the first similarity and the second similarity using the display module 160.

The feature information may include at least one of text information, classification information, and length information of words included in a single sentence, and previous utterance information. The processor 120 may determine the first similarity by comparing classification information included in the feature information of the text and classification information included in the feature information associated with the output domain.

The processor 120 may determine the first similarity by determining a weight of the classification information included in the feature information associated with the output domain, and comparing the classification information included in the feature information of the text and the classification information included in the feature information associated with the output domain based on the weight.

The feature information may include at least one of text information, classification information, and length information of words included in a single sentence, and previous utterance information. The processor 120 may determine the second similarity by comparing the classification information included in the feature information of the text and the classification information included in the feature information associated with the expected domain.

The processor 120 may determine the second similarity by determining a weight of the classification information included in the feature information associated with the expected domain and comparing the classification information included in the feature information of the text and the classification information included in the feature information associated with the expected domain based on the weight.

The processor 120 may display, on the display module 160, the feature information associated with the output domain in an order of feature information having a greatest value in the first similarity to the feature information of the text.

The processor 120 may display, on the display module 160, the feature information associated with the expected domain in an order of feature information having a greatest value in the second similarity to the feature information of the text.

The processor 120 may display, on the display module 160, classification information having a weight greater than a reference in the classification information included in the feature information associated with the output domain.

The processor 120 may display, on the display module 160, classification information having a weight greater than a reference in the classification information included in the feature information associated with the expected domain.

The processor 120 may determine the output domain by inputting the feature information of the text to a learning model trained to determine a domain associated with the user utterance.

The processor 120 may determine the feature information of the text by classifying the text by token information and comparing the token information to token information previously stored in the memory 130.

According to various embodiments of the disclosure, an electronic device 101 may include a display module 160 configured to provide information to the outside of the electronic device 101, a processor 120 electrically connected to the display module 160, and a memory 130 electrically connected to the processor 120. The processor 120 may generate feature information of a text corresponding to a user utterance based on the text, determine an output domain for processing the user utterance based on the generated feature information, extract feature information associated with the output domain from the memory 130, and display the feature information associated with the output domain using the display module 160.

The processor 120 may determine a similarity between the feature information of the text and the feature information associated with the output domain, and display the similarity using the display module 160.

The feature information may include at least one of text information, classification information, and length information of words included in one sentence, and previous utterance information. The processor 120 may determine a similarity by comparing classification information included in the feature information of the text and classification information included in the feature information associated with the output domain.

The processor 120 may determine the similarity by determining a weight of the classification information included in the feature information associated with the output domain and comparing the classification information included in the feature information of the text and the classification information included in the feature information associated with the output domain based on the weight.

According to various embodiments of the disclosure, a method of analyzing a speech recognition result may include generating feature information of a text corresponding to a user utterance based on the text, determining an output domain for processing the user utterance based on the feature information of the text, identifying an expected domain predetermined by a user, extracting feature information associated with the output domain and feature information associated with the expected domain, and displaying the feature information associated with the output domain and the feature information associated with the expected domain.

According to various embodiments of the disclosure, an electronic device may be a device provided in various forms. The electronic device may include, for example, a portable communication device (e.g., a smartphone), a computing device, a portable multimedia device, a portable medical device, a camera, a wearable device, or a home appliance. However, the electronic device is not limited to the foregoing example.

It should be construed that various embodiments of the disclosure and the terms used therein are not intended to limit the technological features set forth herein to particular embodiments but include various changes, equivalents, or replacements of the embodiments. In connection with the description of the drawings, like reference numerals may be used for similar or related components. As used herein, “A or B”, “at least one of A and B,” “at least one of A or B,” “A, B, or C,” “at least one of A, B, and C,” and “A, B, or C,” each of which may include any one of the items listed together in the corresponding one of the phrases, or all possible combinations thereof. Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the disclosure. It should also be understood that, when a component (e.g., a first component) is referred to as being “connected to” or “coupled to” another component with or without the term “functionally” or “communicatively,” the component can be connected or coupled to the other component directly (e.g., wiredly), wirelessly, or via a third component.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment of the disclosure, the module may be implemented in the form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to various embodiments of the disclosure, a method according to an embodiment of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components or operations may be omitted, or one or more other components or operations may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display module configured to provide information to an outside of the electronic device;
a processor electrically connected to the display module; and
a memory electrically connected to the processor,
wherein the processor is configured to:
generate feature information of a text corresponding to a user utterance based on the text,
determine an output domain for processing the user utterance based on the feature information of the text,
identify an expected domain predetermined by a user,
extract, from the memory, feature information associated with the output domain and feature information associated with the expected domain, and
display the feature information associated with the output domain and the feature information associated with the expected domain, using the display module.

2. The electronic device of claim 1, wherein the processor is further configured to:
determine a first similarity between the feature information of the text and the feature information associated with the output domain and a second similarity between the feature information of the text and the feature information associated with the expected domain, and
display the first similarity and the second similarity using the display module.

3. The electronic device of claim 2,
wherein the feature information comprises at least one of text information, classification information, or length information of words comprised in a single sentence, and previous utterance information, and
wherein the processor is further configured to:
determine the first similarity by comparing classification information comprised in the feature information of the text and classification information comprised in the feature information associated with the output domain.

4. The electronic device of claim 3, wherein the processor is further configured to:
determine the first similarity by determining a weight of the classification information comprised in the feature information associated with the output domain and comparing the classification information comprised in the feature information of the text and the classification information comprised in the feature information associated with the output domain based on the weight.

5. The electronic device of claim 2,
wherein the feature information comprises at least one of text information, classification information, or length information of words comprised in a single sentence, and previous utterance information, and
wherein the processor is further configured to:
determine the second similarity by comparing classification information comprised in the feature information of the text and classification information comprised in the feature information associated with the expected domain.

6. The electronic device of claim 5, wherein the processor is further configured to:
determine the second similarity by determining a weight of the classification information comprised in the feature information associated with the expected domain and comparing the classification information comprised in the feature information of the text and the classification information comprised in the feature information associated with the expected domain based on the weight.

7. The electronic device of claim 2, wherein the processor is further configured to:
display, on the display module, the feature information associated with the output domain in an order of feature information with a greatest value in the first similarity to the feature information of the text.

8. The electronic device of claim 2, wherein the processor is further configured to:
display, on the display module, the feature information associated with the expected domain in an order of feature information with a greatest value in the second similarity to the feature information of the text.

9. The electronic device of claim 4, wherein the processor is further configured to:
display, on the display module, classification information having a value in the weight greater than a reference, in the classification information comprised in the feature information associated with the output domain.

10. The electronic device of claim 6, wherein the processor is further configured to:
display, on the display module, classification information having a value in the weight greater than a reference, in the classification information comprised in the feature information associated with the expected domain.

11. The electronic device of claim 1, wherein the processor is further configured to:
determine the output domain by inputting the feature information of the text to a learning model trained to determine a domain associated with the user utterance.

12. The electronic device of claim 1, wherein the processor is further configured to:
determine the feature information of the text by classifying the text by token information and comparing the classified token information and token information previously stored in the memory.

13. An electronic device comprising:
a display module configured to provide information to an outside of the electronic device;
a processor electrically connected to the display module; and
a memory electrically connected to the processor,
wherein the processor is configured to:
generate feature information of a text corresponding to a user utterance based on the text,
determine an output domain for processing the user utterance based on the generated feature information,
extract, from the memory, feature information associated with the output domain, and
display the feature information associated with the output domain using the display module.

14. The electronic device of claim 13, wherein the processor is further configured to:
determine a similarity between the feature information of the text and the feature information associated with the output domain; and
display the similarity using the display module.

15. The electronic device of claim 14,
wherein the feature information comprises at least one of text information, classification information, or length information of words comprised in a single sentence, and previous utterance information, and
wherein the processor is further configured to:
determine the similarity by comparing classification information comprised in the feature information of the text and classification information comprised in the feature information associated with the output domain.

16. The electronic device of claim 15, wherein the processor is further configured to:
determine the similarity by determining a weight of the classification information comprised in the feature information associated with the output domain and comparing the classification information comprised in the feature information of the text and the classification information comprised in the feature information associated with the output domain based on the weight.

17. A method of analyzing a speech recognition result, the method comprising:
generating feature information of a text corresponding to a user utterance based on the text;
determining an output domain for processing the user utterance based on the feature information of the text;
identifying an expected domain predetermined by a user;
extracting feature information associated with the output domain and feature information associated with the expected domain; and
displaying the feature information associated with the output domain and the feature information associated with the expected domain.
